(19) United States
(12) Patent Application Publication
(10) Pub. No.: US 2009/0237331 A1
(43) Pub. Date: Sep. 24, 2009

(54) PLASMA DISPLAY DEVICE

(76) Inventors: Masashi YAMAZAKI, Tokyo (JP); Takashi Fujisaki, Yokohama (JP); Yoshikazu Kanazawa, Kawasaki (JP)

Correspondence Address: MATTINGLY & MALUR, P.C., 1800 DIAGONAL ROAD, SUITE 370, ALEXANDRIA, VA, 22314, US

(21) Appl. No.: 12/328,155

(22) Filed: Dec. 4, 2008

(30) Foreign Application Priority Data
Mar. 19, 2008 (JP) 2008-072059

(51) Int. Cl. G09G 3/28

(52) U.S. Cl. 345/60

(57) ABSTRACT

A drive circuit for a plasma display device has a capacitance C1 connected between a high potential side terminal of a scan driver and a low potential side terminal thereof for applying a predetermined potential to a Y electrode. A with SWY5 clamps a second potential line LN2 connected to the low potential side terminal to a potential Vs. A switch SWY6 clamps the second potential line LN2 to a ground potential, and a switch SWY7 is provided that is capable of cutting off a connection between the second potential line LN2 and the ground potential via the switch SWY6. When the second potential line LN2 is a negative potential, it is possible to cut off the connection to the ground potential by turning the switch SWY7 off. This prevents a current from flowing via a parasitic diode of the switch SWY6.

### CROSS-REFERENCE TO RELATED APPLICATIONS

This application is based upon and claims the benefit of priority of the prior Japanese Patent Application No. 2008-072059, filed on Mar. 19, 2008, the entire contents of which are incorporated herein by reference.

### BACKGROUND OF THE INVENTION

The present invention relates to a plasma display device.

In a drive of a plasma display panel, one field is constituted of a plurality of sub-fields, and a gradation expression is realized by selecting in which sub-field a cell is lighted. Each sub-field is constituted of a reset period initializing a wall charge state on an electrode, an address period adjusting the wall charge state based on a display data and performing a selection of a cell to be lighted, and a sustain period lighting the cell corresponding to the display data (the selected cell depending on the display data is discharge light emitted).

FIG. 6 is a circuit diagram depicting a Y drive circuit to drive a Y electrode (a scan electrode) in a conventional plasma display device. A predetermined voltage is applied to a plurality of the Y electrodes in the Y drive circuit.

The Y drive circuit has switches SW11 to SW19, resistances R11 and R12, diodes D11 to D13, and a capacitance C11. The switches SW11, SW12 and the diodes D1, D2 are a part of a scan driver, and constitute a sub-driver SD driving one Y electrode Y. It is constituted such that a high potential side terminal VDH of the sub-driver SD is capable of connecting to a potential Vsc, and a low potential side terminal VDL of the sub-driver SD is capable of connecting to potentials Vs, Vw, (−Vy), and a ground potential.

In the reset period, the Y drive circuit applies a first reset pulse (a write pulse) of an ultimate potential Vw to the Y electrode by turning the switch SW17 on (setting in a continuity state), and a second reset pulse (an erase pulse) of an ultimate potential (−Vy) to the Y electrode by turning the switches SW12, SW14 on. In the address period, the Y drive circuit applies the potential Vsc to the Y electrode to which the scan pulse is not applied (the non-selected Y electrode) by turning the switch SW11 on and the switch SW12 off, and the scan pulse of the potential (−Vy) to the Y electrode to which the scan pulse is applied (the selected Y electrode) by turning the switch SW11 off and the switch SW12 on. Further, in the sustain period, the Y drive circuit applies a sustain pulse to the Y electrode by which the switches SW18 and SW19 are turned on alternately in the state of the switch SW12 being on, and the potential Vs and the ground potential are supplied alternately.

In the conventional Y drive circuit depicted in FIG. 6, during the address period and when the second reset pulse is applied in the reset period, the low potential side terminal VDL of the sub-driver SD becomes a negative potential by turning the switch SW13 or the switch SW14 on. In order to prevent a current from flowing via a parasitic diode of the switch SW19 when the low potential side terminal VDL of the sub-driver SD becomes the negative potential, a bilateral switch 20 constituted of the switches SW15, SW16 is necessary. On the other hand, by providing the bilateral switch 20, power loss occurs when the sustain pulse is applied in the sustain period. Also, in the conventional Y drive circuit depicted in FIG. 6, a power supply circuit related to each potential in order to supply the potentials Vsc, Vs, Vw, and (−Vy) to the Y electrode is necessary. Refer to Japanese Patent Application Laid-open No. 2007-309999.

### SUMMARY OF THE INVENTION

It is an object of the present invention to provide a plasma display device capable of reducing the number of elements constituting a drive circuit, and decreasing power loss.

The plasma display device of the present invention includes a scan driver applying a predetermined potential to a scan electrode, a capacitance connected between a high potential side terminal of the scan driver and a low potential side terminal of the scan driver, a first switch clamping a potential of the low potential side terminal to a first potential, a second switch clamping the potential of the low potential side terminal to a second potential lower than the first potential, and a third switch connected either between the second switch and a supply terminal of the second potential or between the first switch and the second switch, and in which either a connection point of the first switch and the second switch or a connection point of the first switch and the third switch and the low potential side terminal of the scan driver are connected.

When the potential of the low potential side terminal of the scan driver is lower than the second potential, the third switch is turned off, thereby, a connection to the supply terminal of the second potential can be cut off by only the third switch without providing a bilateral switch constituted of two switches, and it is possible to prevent a current from flowing to the low potential side terminal of the scan driver via a parasitic diode of the second switch. Further, the number of switches is reduced, therefore, it is also possible to decrease power loss.

### BRIEF DESCRIPTION OF THE DRAWINGS

FIG. 1 is a diagram depicting a configuration example of a plasma display device according to an embodiment of the present invention;

FIG. 2 is a circuit diagram depicting a configuration example of an X drive circuit and a Y drive circuit in the present embodiment;

FIG. 3 is a view depicting a configuration example of one field of an image;

FIG. 4 is a waveform diagram depicting an operation example in one sub-field of the drive circuit depicted in FIG. 2;

FIG. 5 is a circuit diagram depicting another configuration example of the Y drive circuit in the present embodiment; and

FIG. 6 is a circuit diagram depicting a configuration example of a Y drive circuit according to a conventional technique.

### DETAILED DESCRIPTION OF THE PREFERRED EMBODIMENTS

Hereinafter, embodiments of the present invention will be explained with reference to accompanying drawings.

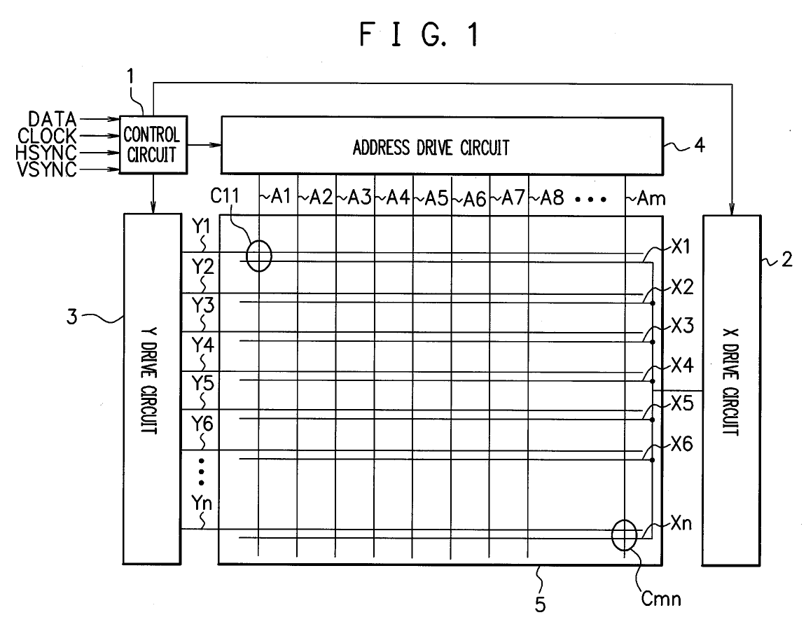

FIG. 1 is a diagram depicting a configuration example of a plasma display device according to an embodiment of the present invention.

AN image data DATA, a clock signal CLOCK, a horizontal synchronization signal HSYNC, and a vertical synchronization signal VSYNC are input to a control circuit 1. The control circuit 1 controls an X drive circuit 2, a Y drive circuit 3, and an address drive circuit 4.

The X drive circuit 2 is configured with circuits repeating a sustain discharge, and supplies a predetermined voltage to a plurality of X electrodes (sustain electrodes) X1, X2, and so on. Hereinafter, each of the X electrodes X1, X2, and so on or their generic name is referred to as an X electrode Xi, i representing a subscript.

The Y drive circuit 3 is configured with circuits selecting a row to be displayed by performing a line-sequential scanning, and repeating the sustain discharge, and supplies a predetermined voltage to a plurality of Y electrodes (scan electrodes) Y1, Y2, and so on. Concretely, the Y drive circuit 3 operates so that a scan pulse is applied to the Y electrodes Y1, Y2 and so on sequentially in an address period, and a sustain pulse (a sustain discharge pulse) is applied to the Y electrodes Y1, Y2, and so on simultaneously in a sustain period (a sustain discharge period). Hereinafter, each of the Y electrodes Y1, Y2, and so on or their generic name is referred to as a Y electrode Yi, i representing a subscript.

The address drive circuit 4 is configured with circuits selecting a column to be displayed, and supplies a predetermined voltage to a plurality of address electrodes A1, A2, and so on. Hereinafter, each of the address electrodes A1, A2, and so on or their generic name is referred to as an address electrode Aj, j representing a subscript.

In a plasma display panel 5, the Y electrodes Yi and the X electrodes Xi form rows extending in parallel in a horizontal direction, and the address electrodes Aj form columns extending in a vertical direction. The Y electrodes Yi and the X electrodes Xi are alternately arranged in the vertical direction. Namely, the Y electrode Yi and the X electrode Xi are arranged in parallel each other, and the address electrode Aj is arranged in approximately the vertical direction to the Y electrode Yi and the X electrode Xi. The Y electrode Yi and the address electrode Aj form a two-dimensional matrix with an i row and a j column.

A cell Cij is formed by an intersection of the Y electrode Yi and the address electrode Aj, and the X electrode Xi adjacent corresponding to it. There is a case that a cell is formed by the intersection of the Y electrode Yi and the address electrode Aj, and the X electrode Xi adjacent correspond to it as well, and a cell is formed by the intersection of the Y electrode Yi and the address electrode Aj, and an X electrode X(i+1) adjacent corresponding to it.

The cell Cij corresponds to sub-pixels of, for example, red, green, and blue, and one pixel is constituted of the sub-pixels of these three colors. The plasma display panel 5 displays an image by lighting a plurality of pixels arranged two-dimensionally. The circuit selecting a row to be displayed by performing a line-sequential scanning of the Y drive circuit 3 and the address drive circuit 4 determine which cell to light, and the X drive circuit 2 and the circuit repeating the sustain discharge of the Y drive circuit 3 perform discharges repeatedly, thereby, a display operation is performed, which enables the plasma display panel 5 to display a two-dimensional image.

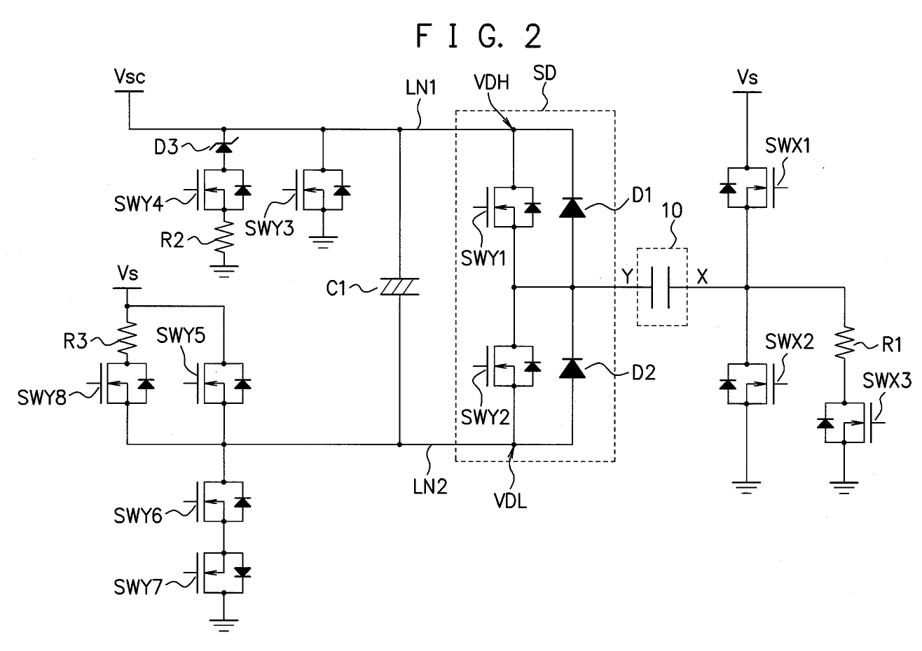

FIG. 2 is a circuit diagram depicting a configuration example of the X drive circuit 2 and the Y drive circuit 3 in the present embodiment. A capacitive load 10 is capacitance of a total of cells formed between the single X electrode X and the single Y electrode Y. In the capacitive load 10, the X electrode X and the Y electrode Y are formed. The X drive circuit 2 applies a predetermined voltage to the X electrode X of the capacitive load 10. The Y drive circuit 3 applies a predetermined voltage to the Y electrode Y of the capacitive load 10.

Hereinafter, an MOS field-effect transistor is simply called a transistor. An n-channel transistor has a parasitic diode, and a source is connected to an anode of the parasitic diode, and a drain is connected to a cathode of the parasitic diode. Further, hereinafter, being connected to a power supply circuit and a supply terminal, which supply a potential P, is referred to as being connected to the potential P.

The X drive circuit is explained. The X drive circuit has switches SWX1 to SWX3, and a resistance R1. Each of switches SWX1 to SWX3 is constituted of the n-channel transistor. The switch SWX1 is connected between the X electrode X and a potential Vs. The switch SWX2 is connected between the X electrode X and a ground potential (a reference potential). The switch SWX3 and the resistance R1 are series-connected between the X electrode X and the ground potential.

The Y drive circuit is explained. The Y drive circuit has switches SWY1 to SWY8, resistances R2 and R3, diodes D1 to D3, and a capacitance (a capacitor element) C1. Each of switches SWY1 to SWY8 is constituted of the n-channel transistor.

The switches SWY1 and SWY2, and the diodes D1 and D2 are a part of a scan driver, and constitute a sub-driver SD driving the single Y electrode Y. The scan driver has sub-drivers, of which the number of the sub-drivers is equal to the number of the driving Y electrodes, and performs a switching operation to output the scan pulse of the Y electrode Y in an address period Ta.

The switch SWY1 is connected between the Y electrode Y and a high potential side terminal VDH of the sub-driver SD. The switch SWY2 is connected between the Y electrode Y and a low potential side terminal VDL of the sub-driver SD. Of the diode D1, its anode is connected to the Y electrode Y, and its cathode is connected to the high potential side terminal VDH of the sub-driver SD. Of the diode D2, its anode is connected to the low potential side terminal VDL of the sub-driver SD, and its cathode is connected to the Y electrode Y.

Further, the high potential side terminals VDH of all the sub-drivers SD that the scan driver has are common-connected to a first potential line LN1. Similarly, the low potential side terminals VDL of all the sub-drivers SD that the scan driver has are common-connected to a second potential line LN2. The first potential line LN1 is connected to a Vsc power supply to supply a potential Vsc. In the present embodiment, the potential Vsc corresponds to an absolute value of a potential of the scan pulse.

The switch SWY3 is connected between the first potential line LN1 and the ground potential. The switch SWY3 can generate the scan pulse of the Y electrode Y in the address period Ta.

The switch SWY4 and the resistance R2 are series-connected between the anode of the diode (a Zener diode) D3 and the ground potential. Of the diode D3, its cathode is connected to the first potential line LN1. A second reset pulse (an erase pulse), being an ultimate potential (−Vsc) of the Y electrode Y in a reset period Tr can be generated by the circuit configured with the switch SWY4, the resistance R2, and the diode D3.

The switch SWY5 is connected between the potential Vs and the second potential line LN2. The switch SWY5 is a switch for a high potential clamp to make the second potential line LN2 be the potential Vs of the sustain pulse.

The switch SWY6 and the switch SWY7 are series-connected between the second potential line LN2 and the ground potential. The switch SWY6 is a switch for a low potential clamp to make the second potential line LN2 be the ground potential. The switch SWY7 is a switch to prevent a current from flowing to the second potential line LN2 via the parasitic diode of the switch SWY6 when the second potential line LN2 becomes a negative potential.

In the example depicted in FIG. 2, the drain of the switch SWY6 is connected to the second potential line LN2, and the source of the switch SWY6 and the source of the switch SWY7 are connected, and the drain of the switch SWY7 is connected to the ground potential. Note that the present embodiment is not limited to this, for example, the source of the switch SWY7 can be connected to the second potential line LN2, and the drain of the switch SWY7 and the drain of the switch SWY6 can be connected, and the source of the switch SWY6 can be connected to the ground potential. That is, a serial connection configuration, which the sources or the drains of the switch SWY6 and the switch SWY7 are connected each other, can be connected between the second potential line LN2 and the ground potential.

The switch SWY8 and the resistance R3 are series-connected between the potential Vs and the second potential line LN2. A first reset pulse (a write pulse), being an ultimate potential (Vsc+Vs) of the Y electrode Y in the reset period Tr can be generated by the circuit configured with the switch SWY8 and the resistance R3. The capacitance C1 is connected between the first potential line LN1 and the second potential line LN2.

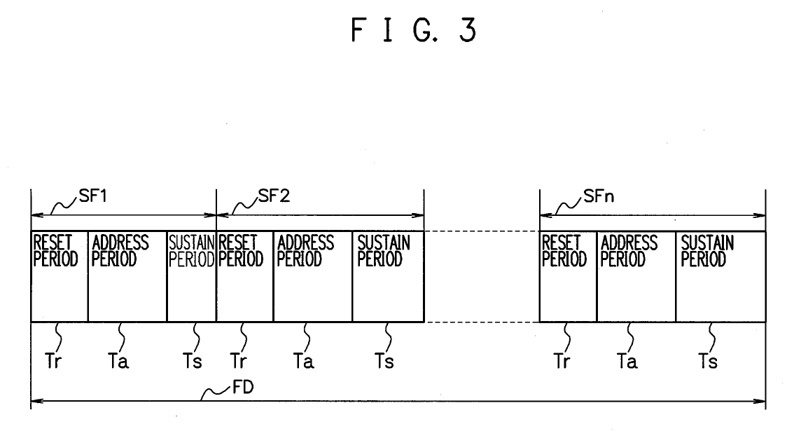

FIG. 3 is a view depicting a configuration example of one field FD of an image. The image is formed of, for example, 60 fields/sec. The one field FD is composed of a first sub-field SF1, a second sub-field SF2, . . . , and an n-th sub-field SFn. This n is, for example, 10 and corresponds to the number of gradation bits. Each of the sub-fields SF1, SF2, and so on or their generic name is, hereinafter, referred to as a sub-field SF.

Each sub-field SF has the reset period Tr, the address period Ta, and a sustain period Ts. In the reset period Tr, initialization of the cell Cij is performed. In the address period Ta, light emission or non-light emission of each cell Cij can be selected by an address discharge between the address electrode Aj and the Y electrode Yi. Concretely, light emission of the cell Cij can be selected by applying the scan pulse to the Y electrodes Y1, Y2, Y3, Y4, . . . , and Yn sequentially, and corresponding to the scan pulse, applying an address pulse to the address electrode Aj. In the sustain period Ts, the sustain discharge is performed between the X electrode Xi and the Y electrode Yi of the cell Cij selected to light emit, and light emission is performed. In each sub-field SF, the number of light emissions by the sustain pulse between the X electrode Xi and the Y electrode Yi (a length of the sustain period Ts) is different. This makes it possible to determine a gradation value.

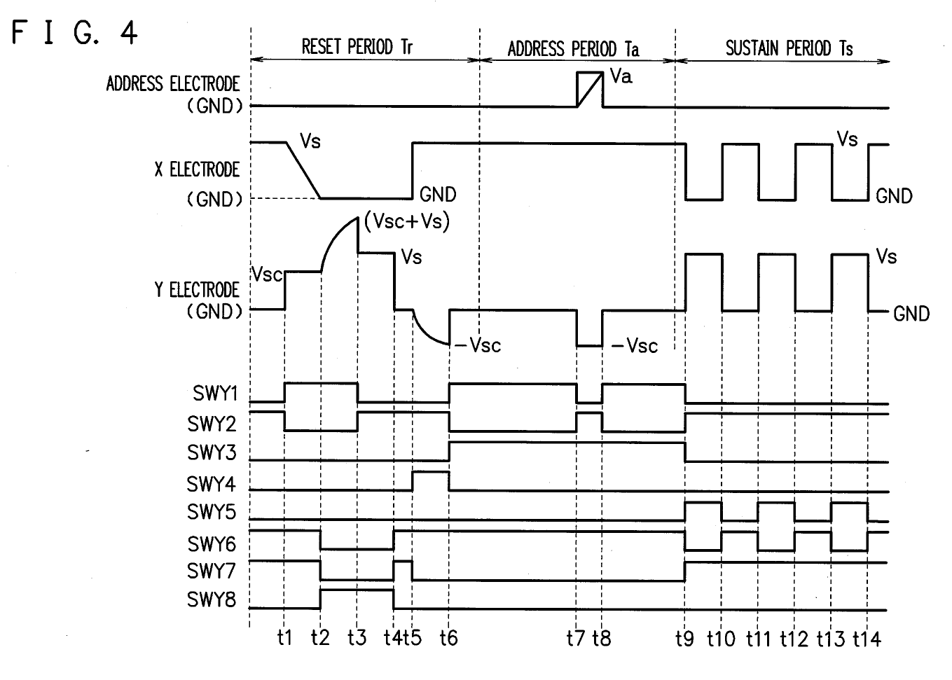

FIG. 4 is a waveform diagram depicting an operation example in one sub-field of the drive circuit depicted in FIG. 2, and depicting a waveform example of voltage of the X electrode, the Y electrode, and the address electrode. The sub-field is divided into the reset period Tr, the address period Ta, and the sustain period Ts.

In the reset period Tr, initialization of the cell Cij is performed. In the reset period, a wall charge is formed by performing a reset discharge (write) with a positive ramp wave applied to the Y electrode all at once, and then an amount of the wall charge of the cell Cij is adjusted by performing a reset discharge (erase) with a negative ramp wave applied to the Y electrode all at once. Note that the positive ramp wave is a waveform having a positive ramp, and an applied voltage shifts to a positive direction continuously as time passes. And the negative ramp wave is a waveform having a negative ramp, and an applied voltage shifts to a negative direction continuously as time passes.

Concretely, in the reset period Tr, before a time t1, the switches SWX1, SWY2, SWY6, and SWY7 are on (in a continuity state) among the respective switches of the drive circuit depicted in FIG. 2, and the other switches are off (in a non-continuity state). At this time, the potential of the X electrode X is the potential Vs, and the potential of the Y electrode Y is the ground potential. And an electric charge depending on a potential difference Vsc is charged in the capacitance C1.

At the time t1, the switch SWX1 is turned off, and the switch SWX3 is turned on. Thereby, the potential of the X electrode X lowers from the potential Vs to the ground potential gradually. Further, the switch SWY1 is turned on and the switch SWY2 is turned off. Thereby the potential Vsc is applied to the Y electrode Y.

And next, at a time t2, the switches SWY6 and SWY7 are turned off, and the switch SWY8 is turned on. Thereby, the potential of the second potential line LN2 rises from the ground potential to the potential Vs gradually, depending on it, as depicted from the time t2 to a time t3, the potential of the first potential line LN1 rises from the potential Vsc to the potential (Vsc+Vs) gradually. Thereby, the first reset pulse (the write pulse) of the ultimate potential (Vsc+Vs), being the positive ramp wave is applied to the Y electrode Y.

At the time t3, the switch SWY1 is turned off, and the switch SWY2 is turned on, and at a subsequent time t4, the switch SWY8 is turned off, and the switches SWY6 and SWY7 are turned on. Thereby, the potential of the Y electrode Y changes from the potential (Vsc+Vs) to the potential Vs, and then changes to the ground potential.

And next, at a time t5, the switch SWX3 is turned off, and the switch SWX1 is turned on. Thereby, the potential Vs is applied to the X electrode X. Further the switch SWY7 is turned off, and the switch SWY4 is turned on. Thereby, the potential of the first potential line LN1 lowers from the potential Vsc to the ground potential gradually, and depending on it, as depicted from the time t5 to a time t6, the potential of the second potential line LN2 lowers from the ground potential to the potential (−Vsc). Thereby, the second reset pulse (the erase pulse) of the ultimate potential (−Vsc), being the negative ramp wave is applied to the Y electrode Y. The potential of the second potential line LN2 lowers from the ground potential to the potential (−Vsc), namely, becoming the negative potential, however, the switch SWY7 is off, therefore, the current does not flow via the parasitic diode of the switch SWY6.

At the time t6, the switches SWY2 and SWY4 are turned off, and the switches SWY1 and SWY3 are turned on. Thereby, the potential of the Y electrode Y becomes the ground potential. At the time t6, the switch SWY4 is constituted to be turned off, however, the timing when the switch SWY4 is turned off is arbitrary as long as being at the time t6 and later and before starting of the address period Ta.

And then, in the address period Ta, a scan operation, which selects either light emission (lighting) or non-light emission (non-lighting) of each cell Cij of a display line by an address designation based on a display data, is performed. In the address period Ta, the scan pulse is applied to the Y electrode Y of the display line sequentially, and corresponding to the scan pulse, the address pulse is applied to the address electrode A. Thereby, a discharge is occurred between the address electrode A and the Y electrode Y, which forms a wall charge in the X electrode X and the Y electrode Y, and light emission or non-light emission of the cell Cij is selected.

Concretely, when the scan pulse is applied to the Y electrode Y, as depicted at times t7, t8, the switch SWY1 is turned off, and the switch SWY2 is turned on. Thereby, the scan pulse of the potential (−Vsc) is applied to the Y electrode Y. If the address pulse (Va) of the address electrode A is generated corresponding to this scan pulse, light emission of the cell Cij, which is formed by the Y electrode Yi, the X electrode Xi, and the address electrode Aj, is selected. On the other hand, if the address pulse of the address electrode A is not generated corresponding to the scan pulse, light emission of the cell Cij, which is formed by the Y electrode Yi, the X electrode Xi, and the address electrode Aj, is not selected, therefore, non-light emission is selected.

In the address period Ta, the potential of the second potential line LN2 is the potential (−Vsc), which is the negative potential, however, the switch SWY7 is off therefore, the current does not flow via the parasitic diode of the switch SWY6.

And then, in the sustain period Ts, the sustain pulse (the potential Vs) is applied to the X electrode X and the Y electrode Y alternately, and the sustain discharge is performed between the X electrode X and the Y electrode Y of the cell selected in the address period Ta, and light emission is performed.

Concretely, at a time t9, the switches SWY1 and SWY3 are turned off, and the switches SWY2 and SWY7 are turned on. In the state, as depicted at the time t9 and later, a first operation, of which the switches SWX1 and SWY6 are turned off and the switch SWX2 and the switch SWY5 are turned on, and a second operation, of which the switches SWX2 and SWY5 are turned off and the switch SWX1 and the switch SWY6 are turned on, are performed alternately. Thereby, the sustain pulse of the potential Vs is applied to the X electrode X and the Y electrode Y alternately.

According to the present embodiment, when the potential of the second potential line LN2, connected to the low potential side terminal VDL of the sub-driver SD that the scan driver has, becomes the negative potential, the switch SWY7 is turned off and the connection of the second potential line LN2 and the ground potential is cut off. Thereby, it makes it possible to separate the second potential line LN2 and the ground potential electrically, and prevent the current from flowing to the second potential line LN2 via the parasitic diode of the switch SWY6. In the case when the potential of the second potential line LN2 does not become the negative potential except in the address period Ta, such as not applying the negative ramp wave to the Y electrode in the reset period Tr, the switch SWY7 is just turned off at least in the address period Ta.

Further, a capacitance C1 is connected between the high potential side terminal VDH (the first potential line LN1) of the sub-driver SD and the low potential side terminal VDL (the second potential line LN2) of the sub-driver SD, and the potentials of the first potential line LN1 and the second potential line LN2 are controlled when necessary, thereby, each pulse applied to the Y electrode Y is generated. Accordingly, in a drive of the plasma display device, the number of the power supply circuits to supply the potential of each pulse to the Y electrode can be reduced.

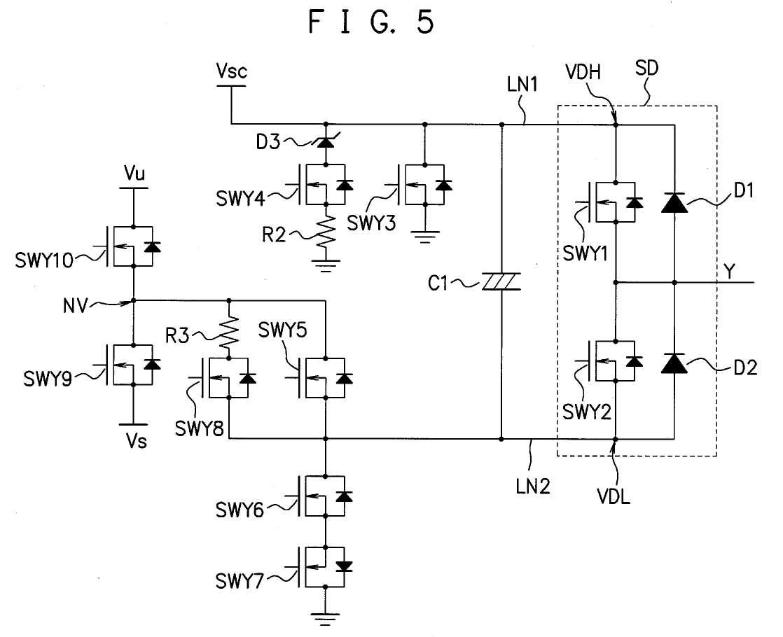

FIG. 5 is a circuit diagram depicting another configuration example of the Y drive circuit in the present embodiment. In FIG. 5, same numerals and symbols are given to the components having the same functions as the components depicted in FIG. 2, and the overlapping explanation is abbreviated.

The Y drive circuit depicted in FIG. 5 can select not only the potential Vs but also either the potential Vs or a potential Vu to provide. The potential Vu, being a little higher than the potential Vs (for example, when the potential Vs is 180V based on the ground potential, the potential Vu is about 210V), is used in the case of such as making a stronger discharge occur in order to stabilize the discharge of the plasma display panel.

A switch SWY9 is connected between the potential Vs and a node NV, and a switch SWY10 is connected between the potential Vu and the node NV. The switch SWY5 is connected between the node NV and the second potential line LN2, and the switch SWY8 and the resistance R3 are series-connected between the node NV and the second potential line LN2. According to this configuration, either the switch SWY9 or the switch SWY10 is turned on selectively, thereby, either the potential Vs or the potential Vu is supplied. For example, as the first reset pulse of the Y electrode Y in the reset period Tr, the pulse, of which the ultimate potential is either (Vsc+Vs) or (Vsc+Vu), can be selected to provide. Similarly, for example, as the sustain pulse in the sustain period Ts, the pulse, of which the potential is either Vs or Vu, can be selected to provide.

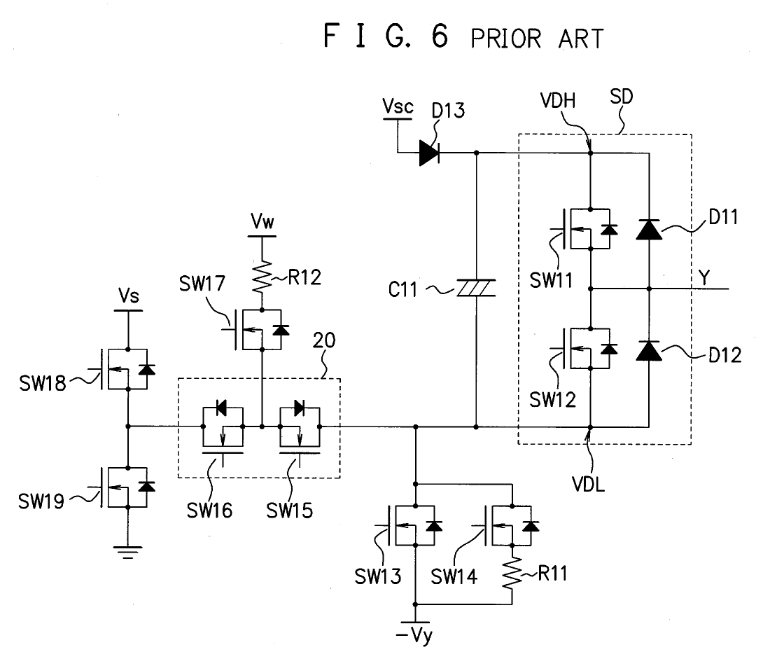

In the present embodiment as described above, the potential related to the capacitance C1 is changed by controlling the potentials of the first potential line LN1 and the second potential line LN2 when necessary, thereby the first reset pulse (the write pulse) and the second reset pulse (the erase pulse) of the Y electrode Y in the reset period Tr, and the scan pulse of the Y electrode Y in the address period Ta are generated, however, each pulse can be generated by using a potential Vw or a power supply of (−Vy) as depicted in FIG. 6.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device comprising:
a scan driver applying a predetermined potential to a scan electrode;
a capacitance connected between a high potential side terminal of the scan driver and a low potential side terminal of the scan driver;
a first switch clamping a potential of the low potential side terminal to a first potential;
a second switch clamping the potential of the low potential side terminal to a second potential lower than the first potential; and
a third switch connected between the second switch and a supply terminal of the second potential, and wherein
a connection point of the first switch and the second switch and the low potential side terminal of the scan driver are connected.

2. The plasma display device according to claim 1, wherein
the third switch is turned off in a period when the potential of the low potential side terminal of the scan driver is lower than the second potential.

3. The plasma display device according to claim 1, wherein
the third switch is turned off in an address period when a scan pulse is applied to the scan electrode.

4. The plasma display device according to claim 1, wherein
the second potential is a ground potential.

5. The plasma display device according to claim 1, wherein
the first potential is selectable from a plurality of different potentials.

6. The plasma display device according to claim 5, further comprising:
a fourth switch connected between the first switch and a supply terminal of a third potential; and
a fifth switch connected between the first switch and a supply terminal of a fourth potential, and wherein
either the third potential or the fourth potential is supplied to the first switch as the first potential.

7. A plasma display device comprising:
a scan driver applying a predetermined potential to a scan electrode;
a capacitance connected between a high potential side terminal of the scan driver and a low potential side terminal of the scan driver;
a first switch clamping a potential of the low potential side terminal to a first potential;
a second switch clamping the potential of the low potential side terminal to a second potential lower than the first potential; and
a third switch connected between the first switch and the second switch, and wherein
a connection point of the first switch and the third switch and the low potential side terminal of the scan driver are connected.

8. The plasma display device according to claim 7, wherein
the third switch is turned off in a period when the potential of the low potential side terminal of the scan driver is lower than the second potential.

9. The plasma display device according to claim 7, wherein
the third switch is turned off in an address period when a scan pulse is applied to the scan electrode.

10. The plasma display device according to claim 7, wherein
the second potential is a ground potential.

11. The plasma display device according to claim 7, wherein
the first potential is selectable from a plurality of different potentials.

12. The plasma display device according to claim 11, further comprising:
a fourth switch connected between the first switch and a supply terminal of a third potential; and
a fifth switch connected between the first switch and a supply terminal of the fourth switch, and wherein
either the third potential or the fourth potential is supplied to the first switch as the first potential.
